(19) United States
(12) Patent Application Publication
(10) Pub. No.: US 2005/0257219 A1
(43) Pub. Date: Nov. 17, 2005

(54) Multiple computer architecture with replicated memory fields

(76) Inventor: John M. Holt, Lindfield (AU)

Correspondence Address: CONNOLLY BOVE LODGE & HUTZ LLP, SUITE 800, 1990 M STREET NW, WASHINGTON, DC, 20036-3425, US

(21) Appl. No.: 11/111,757

(22) Filed: Apr. 22, 2005

Related U.S. Application Data
(63) Continuation-in-part of application No. 10/830,042, filed on Apr. 23, 2004.

(51) Int. Cl. G06F 9/46

(52) U.S. Cl. 718/1; 719/310

(57) ABSTRACT

The present invention discloses a modified computer architecture (50, 71, 72) which enables an applications program (50) to be run simultaneously on a plurality of computers (M1, . . . Mn). Shared memory at each computer is updated with amendments and/or overwrites so that all memory read requests are satisfied locally. During initial program loading (75), or similar, instructions which result in memory being re-written or manipulated are identified (92). Additional instructions are inserted (103) to cause the equivalent memory locations at all computers to be updated.

### FIELD OF THE INVENTION

The present invention relates to computers and, in particular, to a modified machine architecture which enables improved performance to be achieved.

### BACKGROUND ART

Ever since the advent of computers, and computing, software for computers has been written to be operated upon a single machine. As indicated in FIG. 1, that single prior art machine 1 is made up from a central processing unit, or CPU, 2 which is connected to a memory 3 via a bus 4. Also connected to the bus 4 are various other functional units of the single machine 1 such as a screen 5, keyboard 6 and mouse 7.

A fundamental limit to the performance of the machine 1 is that the data to be manipulated by the CPU 2, and the results of those manipulations, must be moved by the bus 4. The bus 4 suffers from a number of problems including so called bus “queues” formed by units wishing to gain an access to the bus, contention problems, and the like. These problems can, to some extent, be alleviated by various stratagems including cache memory, however, such stratagems invariably increase the administrative overhead of the machine 1.

Naturally, over the years various attempts have been made to increase machine performance. One approach is to use symmetric multi-processors. This prior art approach has been used in so called “super” computers and is schematically indicated in FIG. 2. Here a plurality of CPU's 12 are connected to global memory 13. Again, a bottleneck arises in the communications between the CPU's 12 and the memory 13. This process has been termed “Single System Image”. There is only one application and one whole copy of the memory for the application which is distributed over the global memory. The single application can read from and write to, (ie share) any memory location completely transparently.

Where there are a number of such machines interconnected via a network, this is achieved by taking the single application written for a single machine and partitioning the required memory resources into parts. These parts are then distributed across a number of computers to form the global memory 13 accessible by all CPU's 12. This procedure relies on masking, or hiding, the memory partition from the single running application program. The performance degrades when one CPU on one machine must access (via a network) a memory location physically located in a different machine.

Although super computers have been technically successful in achieving high computational rates, they are not commercially successful in that their inherent complexity makes them extremely expensive not only to manufacture but to administer. In particular, the single system image concept has never been able to scale over “commodity” (or mass produced) computers and networks. In particular, the Single System Image concept has only found practical application on very fast (and hence very expensive) computers interconnected by very fast (and similarly expensive) networks.

A further possibility of increased computer power through the use of a plural number of machines arises from the prior art concept of distributed computing which is schematically illustrated in FIG. 3. In this known arrangement, a single application program (Ap) is partitioned by its author (or another programmer who has become familiar with the application program) into various discrete tasks so as to run upon, say, three machines in which case n in FIG. 3 is the integer 3. The intention here is that each of the machines M1 . . . M3 runs a different third of the entire application and the intention is that the loads applied to the various machines be approximately equal. The machines communicate via a network 14 which can be provided in various forms such as a communications link, the internet, intranets, local area networks, and the like. Typically the speed of operation of such networks 14 is an order of magnitude slower than the speed of operation of the bus 4 in each of the individual machines M1, M2, etc.

Distributed computing suffers from a number of disadvantages. Firstly, it is a difficult job to partition the application and this must be done manually. Secondly, communicating data, partial results, results and the like over the network 14 is an administrative overhead. Thirdly, the need for partitioning makes it extremely difficult to scale upwardly by utilising more machines since the application having been partitioned into, say three, does not run well upon four machines. Fourthly, in the event that one of the machines should become disabled, the overall performance of the entire system is substantially degraded.

A further prior art arrangement is known as network computing via “clusters” as is schematically illustrated in FIG. 4. In this approach, the entire application is loaded onto each of the machines M1, M2 . . . Mn. Each machine communicates with a common database but does not communicate directly with the other machines. Although each machine runs the same application, each machine is doing a different “job” and uses only its own memory. This is somewhat analogous to a number of windows each of which sell train tickets to the public. This approach does operate, is scalable and mainly suffers from the disadvantage that it is difficult to administer the network.

### OBJECT OF THE INVENTION

The object of the present invention is to provide a modified machine architecture which goes some way towards overcoming, or at least ameliorating, some of the abovementioned disadvantages.

### SUMMARY OF THE INVENTION

In accordance with a first aspect of the present invention there is disclosed a multiple computer system having at least one application program running simultaneously on a plurality of computers interconnected by a communications network, wherein a like plurality of substantially identical objects are created, each in the corresponding computer.

In accordance with a second aspect of the present invention there is disclosed a plurality of computers interconnected via a communications link and operating at least one application program simultaneously.

In accordance with a third aspect of the present invention there is disclosed a method of running at least one application program on a plurality of computers simultaneously, said computers being interconnected by means of a communications network, said method comprising the step of,
(i) creating a like plurality of substantially identical objects each in the corresponding computer.

In accordance with a fourth aspect of the present invention there is disclosed a method of loading an application program onto each of a plurality of computers, the computers being interconnected via a communications link, the method comprising the step of modifying the application before, during, or after loading and before execution of the relevant portion of the application program.

In accordance with a fifth aspect of the present invention there is disclosed a method of operating at least one application program simultaneously on a plurality of computers all interconnected via a communications link and each having at least a minimum predetermined local memory capacity, said method comprising the steps of:
(i) initially providing each local memory in substantially identical condition,
(ii) satisfying all memory reads and writes generated by said application program from said local memory, and
(iii) communicating via said communications link all said memory writes at each said computer which take place locally to all the remainder of said plurality of computers whereby the contents of the local memory utilised by each said computer, subject to an updating data transmission delay, remains substantially identical.

In accordance with a sixth aspect of the present invention there is disclosed a method of compiling or modifying an application program to run simultaneously on a plurality of computers interconnected via a communications link, said method comprising the steps of:
(i) detecting instructions which share memory records utilizing one of said computers,
(ii) listing all such shared memory records and providing a naming tag for each listed memory record,
(iii) detecting those instructions which write to, or manipulate the contents of, any of said listed memory records, and
(iv) activating an updating propagation routine following each said detected write or manipulate instruction, said updating propagation routine forwarding the re-written or manipulated contents and name tag of each said re-written or manipulated listed memory record to the remainder of said computers.

In accordance with a seventh aspect of the present invention there is disclosed in a multiple thread processing computer operation in which individual threads of a single application program are simultaneously being processed each on a corresponding one of a plurality of computers interconnected via a communications link, the improvement comprising communicating changes in the contents of local memory physically associated with the computer processing each thread to the local memory of each other said computer via said communications link

In accordance with a eighth aspect of the present invention there is disclosed a computer program product which enables the abovementioned methods to be carried out.

### BRIEF DESCRIPTION OF THE DRAWINGS

Embodiments of the present invention will now be described with reference to the drawings in which:

FIG. 1 is a schematic view of the internal architecture of a conventional computer,

FIG. 2 is a schematic illustration showing the internal architecture of known symmetric multiple processors,

FIG. 3 is a schematic representation of prior art distributed computing,

FIG. 4 is a schematic representation of a prior art network computing using clusters,

FIG. 5 is a schematic block diagram of a plurality of machines operating the same application program in accordance with a first embodiment of the present invention,

FIG. 6 is a schematic illustration of a prior art computer arranged to operate JAVA code and thereby constitute a JAVA virtual machine,

FIG. 7 is a drawing similar to FIG. 6 but illustrating the initial loading of code in accordance with the preferred embodiment,

FIG. 8 is a drawing similar to FIG. 5 but illustrating the interconnection of a plurality of computers each operating JAVA code in the manner illustrated in FIG. 7,

FIG. 9 is a flow chart of the procedure followed during loading of the same application on each machine in the network,

FIG. 10 is a flow chart showing a modified procedure similar to that of FIG. 9,

FIG. 11 is a schematic representation of multiple thread processing carried out on the machines of FIG. 8 utilizing a first embodiment of memory updating,

FIG. 12 is a schematic representation similar to FIG. 11 but illustrating an alternative embodiment,

FIG. 13 illustrates multi-thread memory updating for the computers of FIG. 8,

FIG. 14 is a schematic representation of two laptop computers interconnected to simultaneously run a plurality of applications, with both applications running on a single computer,

FIG. 15 is a view similar to FIG. 14 but showing the FIG. 14 apparatus with one application operating on each computer, and

FIG. 16 is a view similar to FIGS. 14 and 15 but showing the FIG. 14 apparatus with both applications operating simultaneously on both computers.

The specification includes an Annexure which provides actual program fragments which implement various aspects of the described embodiments.

### DETAILED DESCRIPTION

In connection with FIG. 5, in accordance with a preferred embodiment of the present invention a single application program 50 can be operated simultaneously on a number of machines M1, M2 . . . Mn communicating via network 53. As it will become apparent hereafter, each of the machines M1, M2 . . . Mn operates with the same application program 50 on each machine M1, M2 . . . Mn and thus all of the machines M1, M2 . . . Mn have the same application code and data 50. Similarly, each of the machines M1, M2 . . . Mn operates with the same (or substantially the same) modifier 51 on each machine M1, M2 . . . Mn and thus all of the machines M1, M2 . . . Mn have the same (or substantially the same) modifier 51 with the modifier of machine M2 being designated 51/2. In addition, during the loading of, or preceding the execution of, the application 50 on each machine M1, M2 . . . Mn, each application 50 has been modified by the corresponding modifier 51 according to the same rules (or substantially the same rules since minor optimising changes are permitted within each modifier 51/1 . . . 51/n).

As a consequence of the above described arrangement, if each of the machines M1, M2 . . . Mn has, say, a shared memory capability of 10 MB, then the total shared memory available to each application 50 is not, as one might expect, 10 n MB but rather only 10 MB. However, how this results in improved operation will become apparent hereafter. Naturally, each machine M1, M2 . . . Mn has an unshared memory capability. The unshared memory capability of the machines M1, M2 . . . Mn are normally approximately equal but need not be.

It is known from the prior art to operate a machine (produced by one of various manufacturers and having an operating system operating in one of various different languages) in a particular language of the application, by creating a virtual machine as schematically illustrated in FIG. 6. The prior art arrangement of FIG. 6 takes the form of the application 50 written in the Java language and executing within a Java Virtual Machine 61. Thus, where the intended language of the application is the language JAVA, a JAVA virtual machine is created which is able to operate code in JAVA irrespective of the machine manufacturer and internal details of the machine. For further details see “The JAVA Virtual Machine Specification” 2^{nd} Edition by T. Lindholm & F. Yellin of Sun Microsystems Inc. of the USA.

This well known prior art arrangement of FIG. 6 is modified in accordance with the preferred embodiment of the present invention by the provision of an additional facility which is conveniently termed “distributed run time” or DRT 71 as seen in FIG. 7. In FIG. 7, the application 50 is loaded onto the Java Virtual Machine 72 via the distributed runtime system 71 through the loading procedure indicated by arrow 75. A distributed run time system is available from the Open Software Foundation under the name of Distributed Computing Environment (DCE). In particular, the distributed runtime 71 comes into operation during the loading procedure indicated by arrow 75 of the JAVA application 50 so as to initially create the JAVA virtual machine 72. The sequence of operations during loading will be described hereafter in relation to FIG. 9.

FIG. 8 shows in modified form the arrangement of FIG. 5 utilising JAVA virtual machines, each as illustrated in FIG. 7. It will be apparent that again the same application 50 is loaded onto each machine M1, M2 . . . Mn. However, the communications between each machine M1, M2 . . . Mn, and indicated by arrows 83, although physically routed through the machine hardware, are controlled by the individual DRT's 71/1 . . . 71/n within each machine. Thus, in practice this may be conceptionalised as the DRT's 71/1 . . . 71/n communicating with each other via the network 73 rather than the machines M1, M2 . . . Mn themselves.

Turning now to FIGS. 7 and 9, during the loading procedure 75, the program 50 being loaded to create each JAVA virtual machine 72 is modified. This modification commences at 90 in FIG. 9 and involves the initial step 91 of detecting all memory locations (termed fields in JAVA—but equivalent terms are used in other languages) in the application 50 being loaded. Such memory locations need to be identified for subsequent processing at steps 92 and 93. The DRT 71 during the loading procedure 75 creates a list of all the memory locations thus identified, the JAVA fields being listed by object and class. Both volatile and synchronous fields are listed.

The next phase (designated 92 in FIG. 9) of the modification procedure is to search through the executable application code in order to locate every processing activity that manipulates or changes field values corresponding to the list generated at step 91 and thus writes to fields so the value at the corresponding memory location is changed. When such an operation (typically putstatic or putfield in the JAVA language) is detected which changes the field value, then an “updating propagation routine” is inserted by step 93 at this place in the program to ensure that all other machines are notified that the value of the field has changed. Thereafter, the loading procedure continues in a normal way as indicated by step 94 in FIG. 9.

An alternative form of initial modification during loading is illustrated in FIG. 10. Here the start and listing steps 90 and 91 and the searching step 92 are the same as in FIG. 9. However, rather than insert the “updating propagation routine” as in step 93 in which the processing thread carries out the updating, instead an “alert routine” is inserted at step 103. The “alert routine” instructs a thread or threads not used in processing and allocated to the DRT, to carry out the necessary propagation. This step 103 is a quicker alternative which results in lower overhead.

Once this initial modification during the loading procedure has taken place, then either one of the multiple thread processing operations illustrated in FIGS. 11 and 12 takes place. As seen in FIG. 11, multiple thread processing 110 on the machines consisting of threads 111/1 . . . 111/4 is occurring and the processing of the second thread 111/2 (in this example) results in that thread 111/2 becoming aware at step 113 of a change of field value. At this stage the normal processing of that thread 111/2 is halted at step 114, and the same thread 111/2 notifies all other machines M2 . . . Mn via the network 53 of the identity of the changed field and the changed value which occurred at step 113. At the end of that communication procedure, the thread 111/2 then resumes the processing at step 115 until the next instance where there is a change of field value.

In the alternative arrangement illustrated in FIG. 12, once a thread 121/2 has become aware of a change of field value at step 113, it instructs DRT processing 120 (as indicated by step 125 and arrow 127) that another thread(s) 121/1 allocated to the DRT processing 120 is to propagate in accordance with step 128 via the network 53 to all other machines M2 . . . Mn the identity of the changed field and the changed value detected at step 113. This is an operation which can be carried out quickly and thus the processing of the initial thread 111/2 is only interrupted momentarily as indicated in step 125 before the thread 111/2 resumes processing in step 115. The other thread 121/1 which has been notified of the change (as indicated by arrow 127) then communicates that change as indicated in step 128 via the network 53 to each of the other machines M2 . . . Mn.

This second arrangement of FIG. 12 makes better utilisation of the processing power of the various threads 111/1 . . . 111/3 and 121/1 (which are not, in general, subject to equal demands) and gives better scaling with increasing size of “n”, (n being an integer greater than or equal to 2 which represents the total number of machines which are connected to the network 53 and which run the application program 50 simultaneously). Irrespective of which arrangement is used, the changed field and identities and values detected at step 113 are propagated to all the other machines M2 . . . Mn on the network.

This is illustrated in FIG. 13 where the DRT 71/1 and its thread 121/1 of FIG. 12 (represented by step 128 in FIG. 13) sends via the network 53 the identity and changed value of the listed memory location generated at step 113 of FIG. 12 by processing in machine M1, to each of the other machines M2 . . . Mn.

Each of the other machines M2 . . . Mn carries out the action indicated by steps 135 and 136 in FIG. 13 for machine Mn by receiving the identity and value pair from the network 53 and writing the new value into the local corresponding memory location.

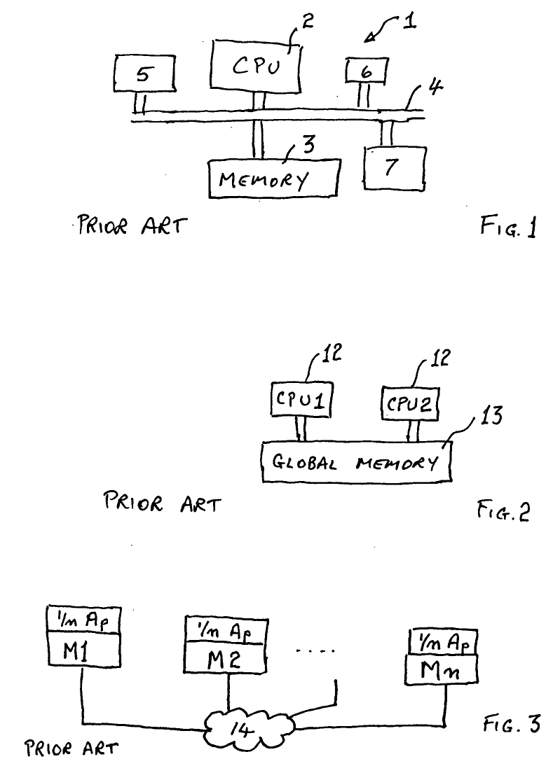

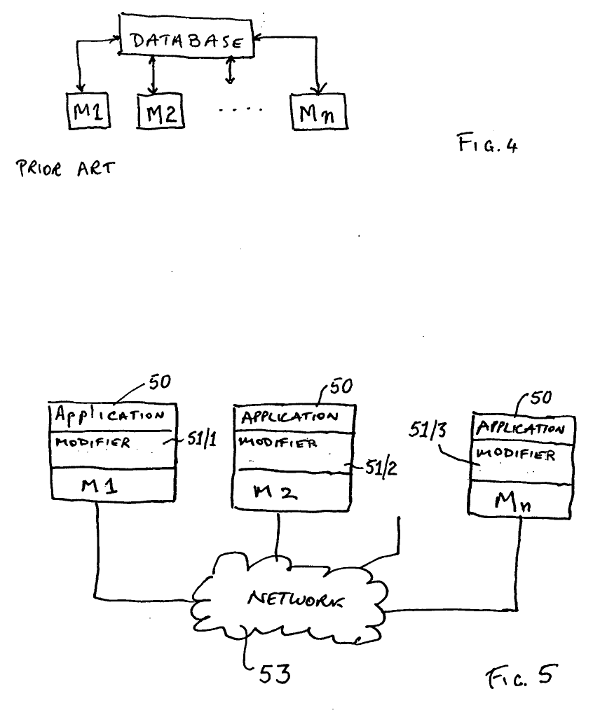

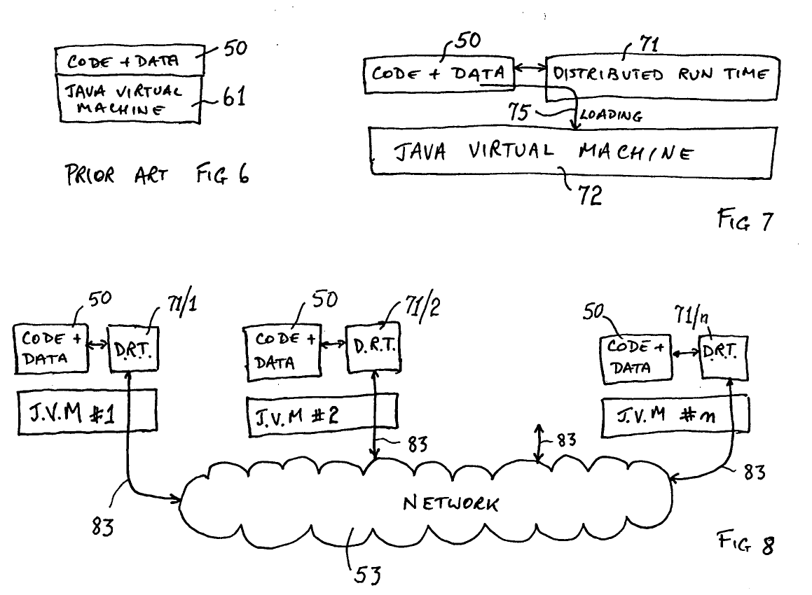

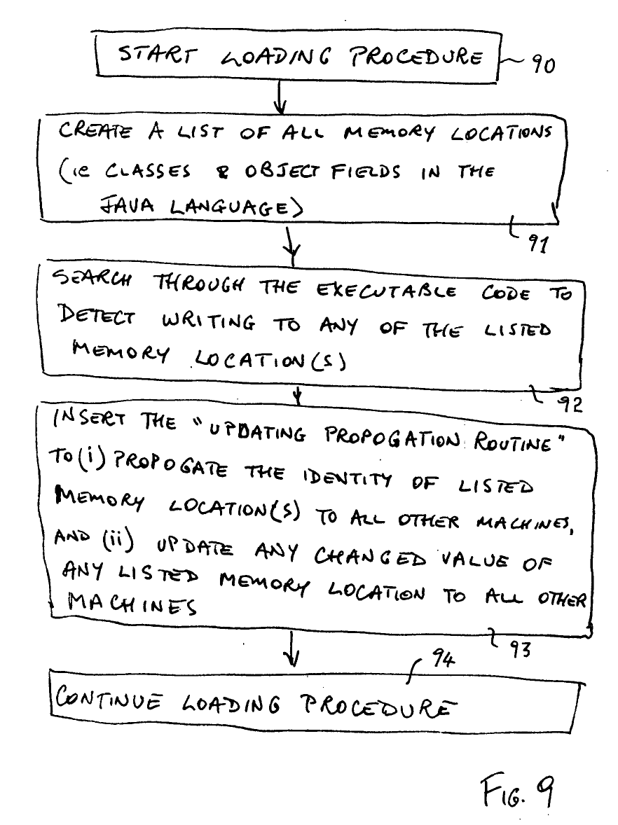

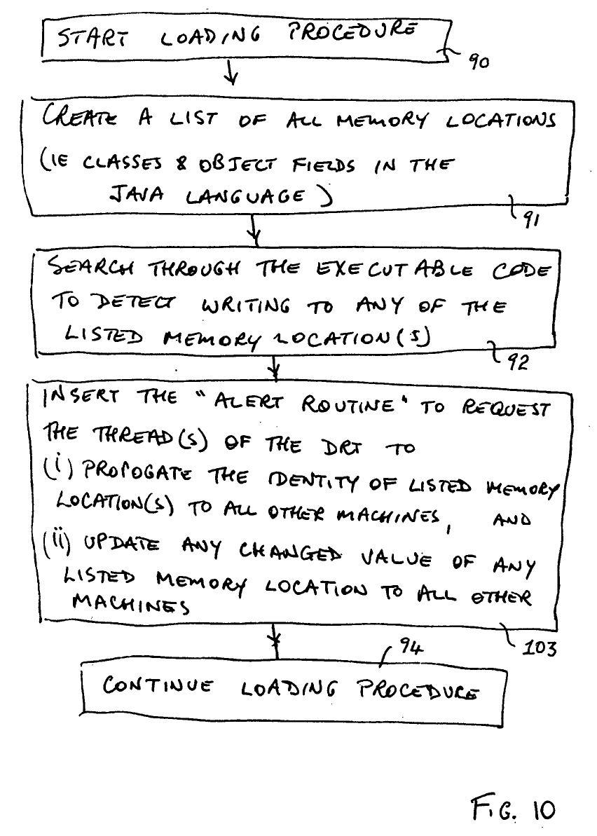

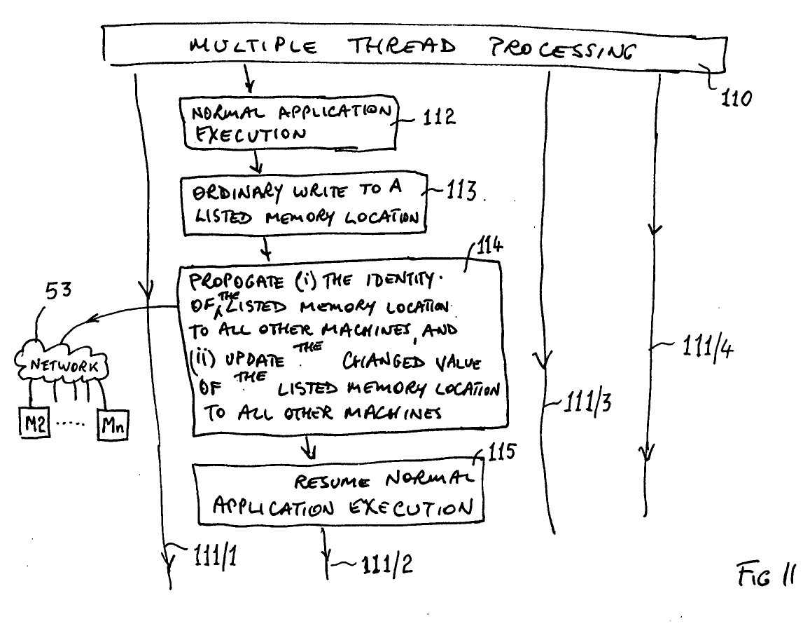

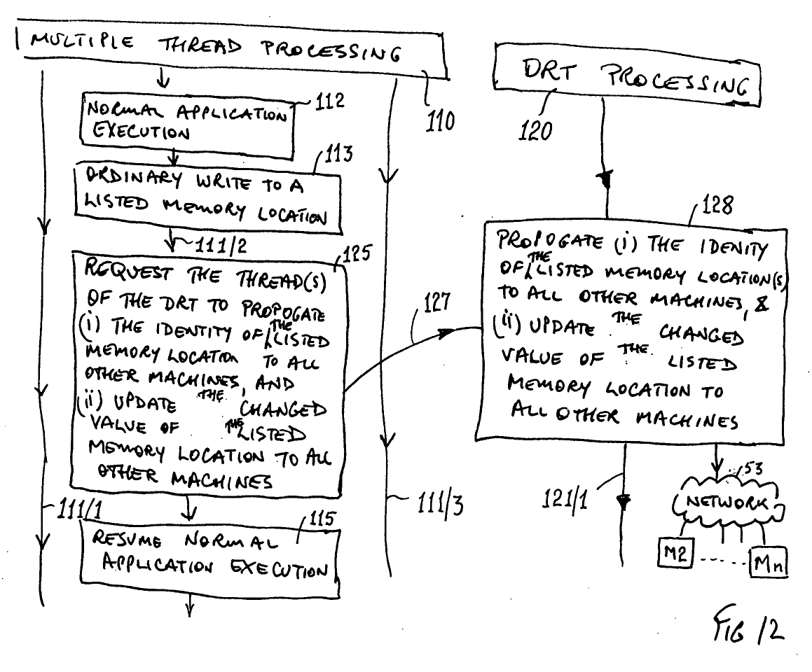

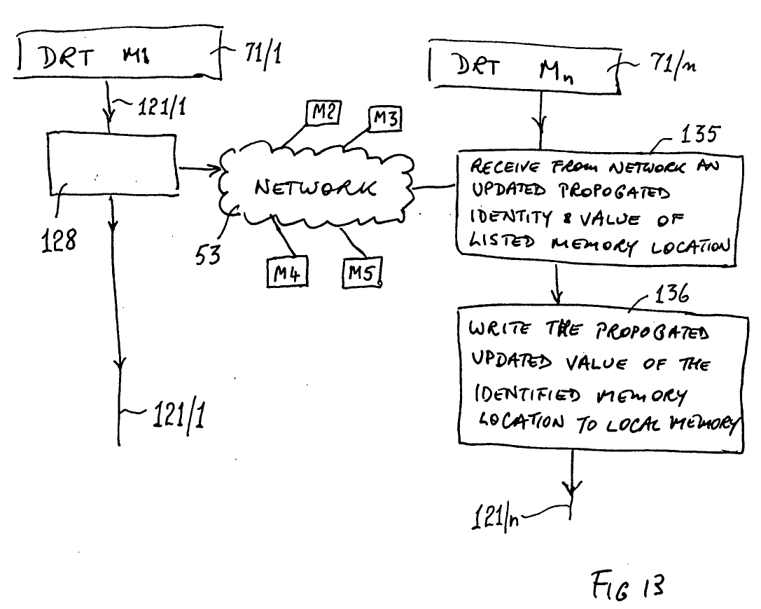

In the prior art arrangement in FIG. 3 utilising distributed software, memory accesses from one machine's software to memory physically located on another machine are permitted by the network interconnecting the machines. However, such memory accesses can result in delays in processing of the order of 10⁶-10⁷ cycles of the central processing unit of the machine. This in large part accounts for the diminished performance of the multiple interconnected machines.

However, in the present arrangement as described above in connection with FIG. 8, it will be appreciated that all reading of data is satisfied locally because the current value of all fields is stored on the machine carrying out the processing which generates the demand to read memory. Such local processing can be satisfied within 10²-10³ cycles of the central processing unit. Thus, in practice, there is substantially no waiting for memory accesses which involves reads.

However, most application software reads memory frequently but writes to memory relatively infrequently. As a consequence, the rate at which memory is being written or re-written is relatively slow compared to the rate at which memory is being read. Because of this slow demand for writing or re-writing of memory, the fields can be continually updated at a relatively low speed via the inexpensive commodity network 53, yet this low speed is sufficient to meet the application program's demand for writing to memory. The result is that the performance of the FIG. 8 arrangement is vastly superior to that of FIG. 3.

In a further modification in relation to the above, the identities and values of changed fields can be grouped into batches so as to further reduce the demands on the communication speed of the network 53 interconnecting the various machines.

It will also be apparent to those skilled in the art that in a table created by each DRT 71 when initially recording the fields, for each field there is a name or identity which is common throughout the network and which the network recognises. However, in the individual machines the memory location corresponding to a given named field will vary over time since each machine will progressively store changed field values at different locations according to its own internal processes. Thus the table in each of the DRTs will have, in general, different memory locations but each global “field name” will have the same “field value” stored in the different memory locations.

It will also be apparent to those skilled in the art that the abovementioned modification of the application program during loading can be accomplished in up to five ways by:
(i) re-compilation at loading,
(ii) by a pre-compilation procedure prior to loading,
(iii) compilation prior to loading,
(iv) a “just-in-time” compilation, or
(v) re-compilation after loading (but, or for example, before execution of the relevant or corresponding application code in a distributed environment).

Traditionally the term “compilation” implies a change in code or language, eg from source to object code or one language to another. Clearly the use of the term “compilation” (and its grammatical equivalents) in the present specification is not so restricted and can also include or embrace modifications within the same code or language.

In the first embodiment, a particular machine, say machine M2, loads the application code on itself, modifies it, and then loads each of the other machines M1, M3 . . . Mn (either sequentially or simultaneously) with the modified code. In this arrangement, which may be termed “master/slave”, each of machines M1, M3, . . . Mn loads what it is given by machine M2.

In a still further embodiment, each machine receives the application code, but modifies it and loads the modified code on that machine. This enables the modification carried out by each machine to be slightly different being optimized based upon its architecture and operating system, yet still coherent with all other similar modifications.

In a further arrangement, a particular machine, say M1, loads the unmodified code and all other machines M2, M3 . . . Mn do a modification to delete the original application code and load the modified version.

In all instances, the supply can be branched (ie M2 supplies each of M1, M3, M4, etc directly) or cascaded or sequential (ie M2 applies M1 which then supplies M3 which then supplies M4, and so on).

In a still further arrangement, the machines M1 to Mn, can send all load requests to an additional machine (not illustrated) which is not running the application program, which performs the modification via any of the aforementioned methods, and returns the modified routine to each of the machines M1 to Mn which then load the modified routine locally. In this arrangement, machines M1 to Mn forward all load requests to this additional machine which returns a modified routine to each machine. The modifications performed by this additional machine can include any of the modifications covered under the scope of the present invention.

Persons skilled in the computing arts will be aware of at least four techniques used in creating modifications in computer code. The first is to make the modification in the original (source) language. The second is to convert the original code (in say JAVA) into an intermediate representation (or intermediate language). Once this conversion takes place the modification is made and then the conversion is reversed. This gives the desired result of modified JAVA code.

The third possibility is to convert to machine code (either directly or via the abovementioned intermediate language). Then the machine code is modified before being loaded and executed. The fourth possibility is to convert the original code to an intermediate representation, which is then modified and subsequently converted into machine code.

The present invention encompasses all four modification routes and also a combination of two, three or even all four, of such routes.

Turning now to FIGS. 14-16, two laptop computers 101 and 102 are illustrated. The computers 101 and 102 are not necessarily identical and indeed, one can be an IBM or IBM-clone and the other can be an APPLE computer. The computers 101 and 102 have two screens 105, 115 two keyboards 106, 116 but a single mouse 107. The two machines 101, 102 are interconnected by a means of a single coaxial cable or twisted pair cable 314.

Two simple application programs are downloaded onto each of the machines 101, 102, the programs being modified as they are being loaded as described above. In this embodiment the first application is a simple calculator program and results in the image of a calculator 108 being displayed on the screen 105. The second program is a graphics program which displays four coloured blocks 109 which are of different colours and which move about at random within a rectangular box 310. Again, after loading, the box 310 is displayed on the screen 105. Each application operates independently so that the blocks 109 are in random motion on the screen 105 whilst numerals within the calculator 108 can be selected (with the mouse 107) together with a mathematical operator (such as addition or multiplication) so that the calculator 108 displays the result.

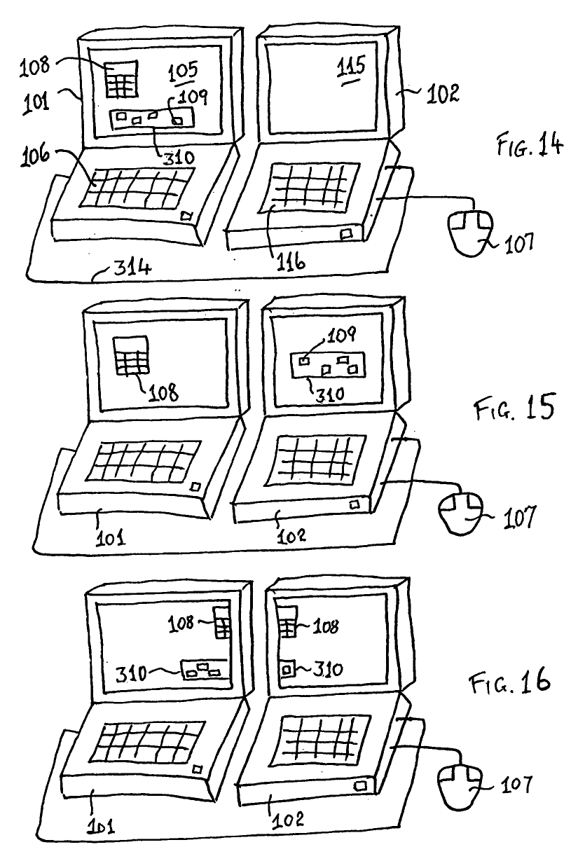

The mouse 107 can be used to “grab” the box 310 and move same to the right across the screen 105 and onto the screen 115 so as to arrive at the situation illustrated in FIG. 15. In this arrangement, the calculator application is being conducted on machine 101 whilst the graphics application resulting in display of box 310 is being conducted on machine 102.

However, as illustrated in FIG. 16, it is possible by means of the mouse 107 to drag the calculator 108 to the right as seen in FIG. 13 so as to have a part of the calculator 108 displayed by each of the screens 105, 115. Similarly, the box 310 can be dragged by means of the mouse 107 to the left as seen in FIG. 15 so that the box 310 is partially displayed by each of the screens 105, 115 as indicated FIG. 16. In this configuration, part of the calculator operation is being performed on machine 101 and part on machine 102 whilst part of the graphics application is being carried out the machine 101 and the remainder is carried out on machine 102.

The foregoing describes only some embodiments of the present invention and modifications, obvious to those skilled in the art, can be made thereto without departing from the scope of the present invention. For example, reference to JAVA includes both the JAVA language and also JAVA platform and architecture.

Those skilled in the programming arts will be aware that when additional code or instructions is/are inserted into an existing code or instruction set to modify same, the existing code or instruction set may well require further modification (eg by re-numbering of sequential instructions) so that offsets, branching, attributes, mark up and the like are catered for.

Similarly, in the JAVA language memory locations include, for example, both fields and array types. The above description deals with fields and the changes required for array types are essentially the same mutatis mutandis. Also the present invention is equally applicable to similar programming languages (including procedural, declarative and object orientated) to JAVA including Microsoft.NET platform and architecture (eg Visual Basic, Visual C/C⁺⁺and C#), FORTRAN, C/C⁺⁺, COBOL, BASIC etc.

The abovementioned arrangement, in which the JAVA code which updates field values is modified, is based on the assumption that either the runtime system (say, JAVA HOTSPOT VIRTUAL MACHINE written in C and Java) or the operating system (LINUX written in C and Assembler, for example) of each machine M1 . . . Mn will ordinarily update memory on the local machine but not on any corresponding other machines. It is possible to leave the JAVA code which updates field values unamended and instead amend the LINUX or HOTSPOT routine which updates memory locally, so that it correspondingly updates memory on all other machines as well. In order to embrace such an arrangement the term “updating propagation routine” used herein in conjunction with maintaining the memory of all machines M1 . . . Mn essentially the same, is to be understood to include within its scope both the JAVA routine and the “combination” of the JAVA routine and the LINUX or HOTSPOT code fragments which perform memory updating.

The terms object and class used herein are derived from the JAVA environment and are intended to embrace similar terms derived from different environments such as dynamically linked libraries (DLL), or object code packages, or function unit or memory locations.

The term “comprising” (and its grammatical variations) as used herein is used in the inclusive sense of “having” or “including” and not in the exclusive sense of “consisting only of”.

Copyright Notice

This patent specification contains material which is subject to copyright protection. The copyright owner (which is the applicant) has no objection to the reproduction of this patent specification or related materials from publicly available associated Patent Office files for the purposes of review, but otherwise reserves all copyright whatsoever. In particular, the various instructions are not to be entered into a computer without the specific written approval of the copyright owner.

1. A multiple computer system having at least one application program running simultaneously on a plurality of computers interconnected by a communications network, wherein a like plurality of substantially identical objects are created, each in the corresponding computer.

2. The system as claimed in claim 1 wherein each of said plurality of substantially identical objects has a substantially identical name.

3. The system as claimed in claim 2 wherein each said computer includes a distributed run time means with the distributed run time means of each said computer able to communicate with all other computers whereby if a portion of said application program(s) running on one of said computers changes the contents of an object in that computer then the change in content for said object is propagated by the distributed run time means of said one computer to all other computers to change the content of the corresponding object in each of said other computers.

4. The system as claimed in claim 3 wherein each said application program is modified before, during, or after loading by inserting an updating propagation routine to modify each instance at which said application program writes to memory, said updating propagation routine propagating every memory write by one computer to all said other computers.

5. The system as claimed in claim 4 wherein the application program is modified in accordance with a procedure selected from the group of procedures consisting of re-compilation at loading, pre-compilation prior to loading, compilation prior to loading, just-in-time compilation, and re-compilation after loading and before execution of the relevant portion of application program.

6. The system as claimed in claim 3 wherein said modified application program is transferred to all said computers in accordance with a procedure selected from the group consisting of master/slave transfer, branched transfer and cascaded transfer.

7. A plurality of computers interconnected via a communications link and operating at least one application program simultaneously.

8. The plurality of computers as claimed in claim 7 wherein each said computer in operating said at least one application program reads and writes only to local memory physically located in each said computer, the contents of the local memory utilized by each said computer is fundamentally similar but not, at each instant, identical, and every one of said computers has distribution update means to distribute to all other said computers the value of any memory location updated by said one computer.

9. The plurality of computers as claimed in claim 8 wherein the local memory capacity allocated to the or each said application program is substantially identical and the total memory capacity available to the or each said application program is said allocated memory capacity.

10. The plurality of computers as claimed in claim 8 wherein all said distribution update means communicate via said communications link at a data transfer rate which is substantially less than the local memory read rate.

11. The plurality of computers as claimed in claim 7 wherein at least some of said computers are manufactured by different manufacturers and/or have different operating systems.

12. A method of running at least one application program on a plurality of computers simultaneously, said computers being interconnected by means of a communications network, said method comprising the step of,
(i) creating a like plurality of substantially identical objects each in the corresponding computer.

13. The method as claimed in claim 12 comprising the further step of,
(ii) naming each of said plurality of substantially identical objects with a substantially identical name.

14. The method as claimed in claim 13 comprising the further step of,
(iii) if a portion of said application program running on one of said computers changes the contents of an object in that computer, then the change in content of said object is propagated to all of the other computers via said communications network to change the content of the corresponding object in each of said other computers.

15. The method as claimed in claim 14 including the further step of:
(iv) modifying said application program before, during or after loading by inserting an updating propagation routine to modify each instance at which said application program writes to memory, said updating propagation routine propagating every memory write by one computer to all said other computers.

16. The method as claimed in claim 15 including the further step of:
(v) modifying said application program utilizing a procedure selected from the group of procedures consisting of re-compilation at loading, pre-compilation prior to loading, compilation prior to loading, just-in-time compilation, and re-compilation after loading and before execution of the relevant portion of application program.

17. The method as claimed in claim 14 including the further step of:
(vi) transferring the modified application program to all said computers utilizing a procedure selected from the group consisting of master/slave transfer, branched transfer and cascaded transfer.

18. A method of loading an application program onto each of a plurality of computers, the computers being interconnected via a communications link, the method comprising the step of modifying the application before, during, or after loading and before execution of the relevant portion of the application program.

19. The method as claimed in claim 18 wherein the modification of the application is different for different computers.

20. The method as claimed in claim 18 wherein said modifying step comprises:
(i) detecting instructions which share memory records utilizing one of said computers,
(ii) listing all such shared memory records and providing a naming tag for each listed memory record,
(iii) detecting those instructions which write to, or manipulate the contents of, any of said listed memory records, and
(iv) generating an updating propagation routine corresponding to each said detected write or manipulate instruction, said updating propagation routine forwarding the re-written or manipulated contents and name tag of each said re-written or manipulated listed memory record to all of the others of said computers.

21. A method of operating at least one application program simultaneously on a plurality of computers all interconnected via a communications link and each having at least a minimum predetermined local memory capacity, said method comprising the steps of:
(i) initially providing each local memory in substantially identical condition,
(ii) satisfying all memory reads and writes generated by said application program from said local memory, and
(iii) communicating via said communications link all said memory writes at each said computer which take place locally to all the remainder of said plurality of computers whereby the contents of the local memory utilised by each said computer, subject to an updating data transmission delay, remains substantially identical.

22. The method as claimed in claim 21 including the further step of:
(iv) communicating said local memory writes constituting an updating data transmission at a data transfer rate which is substantially less than the local memory read rate.

23. A method of compiling or modifying an application program to run simultaneously on a plurality of computers interconnected via a communications link, said method comprising the steps of:
(i) detecting instructions which share memory records utilizing one of said computers,
(ii) listing all such shared memory records and providing a naming tag for each listed memory record,
(iii) detecting those instructions which write to, or manipulate the contents of, any of said listed memory records, and
(iv) activating an updating propagation routine following each said detected write or manipulate instruction, said updating propagation routine forwarding the re-written or manipulated contents and name tag of each said re-written or manipulated listed memory record to the remainder of said computers.

24. The method as claimed in claim 23 and carried out prior to loading the application program onto each said computer, or during loading of the application program onto each said computer, or after loading of the application program onto each said computer and before execution of the relevant portion of the application program.

25. In a multiple thread processing computer operation in which individual threads of a single application program are simultaneously being processed each on a corresponding one of a plurality of computers interconnected via a communications link, the improvement comprising communicating changes in the contents of local memory physically associated with the computer processing each thread to the local memory of each other said computer via said communications link.

26. The improvement as claimed in claim 25 wherein changes to the memory associated with one said thread are communicated by the computer of said one thread to all other said computers.

27. The improvement as claimed in claim 25 wherein changes to the memory associated with one said thread are transmitted to the computer associated with another said thread and are transmitted thereby to all said other computers.

28. A computer program product comprising a set of program instructions stored in a storage medium and operable to permit a plurality of computers to carry out the method as claimed in claim 12 or 18 or 21 or 23.

29. A plurality of computers interconnected via a communication network and operable to run an application program running simultaneously on said computers, said computers being programmed to carry out the method as claimed in claim 12 or 18 or 21 or 23 or being loaded with the computer program product as claimed in claim 28.
